(19) United States
(12) Patent Application Publication
(10) Pub. No.: US 2013/0096987 A1
(43) Pub. Date: Apr. 18, 2013

(54) CITIZEN ENGAGEMENT FOR ENERGY EFFICIENT COMMUNITIES

(71) Applicant: UT Battelle, LLC, Oak Ridge, TN (US)

(72) Inventors: Olufemi Abayomi Omitaomu, Knoxville, TN (US); Budhendra Lal Bhaduri, Knoxville, TN (US)

(73) Assignee: UT Battelle, LLC, Oak Ridge, TN (US)

(21) Appl. No.: 13/645,251

(22) Filed: Oct. 4, 2012

Related U.S. Application Data
(60) Provisional application No. 61/543,830, filed on Oct. 6, 2011.

(51) Int. Cl. G06Q 30/02

(52) U.S. Cl. CPC G06Q 30/0205
USPC 705/7.34

(57) ABSTRACT

An analytic system includes a communication interface that connects to a client device. A front-end cluster acquires user billing and consumption data from one or more utility database machines and acquires geographic information system data. A geocoding server converts selected data rendered by the front-end cluster into geographic coordinates. The front-end cluster is configured to render comparisons of a user's utility usage to peer group usages.

### RELATED APPLICATION

This application claims the benefit of priority of U.S. Provisional Patent Application No. 61/543,830 filed Oct. 6, 2011 and titled “Citizen Engagement for Energy Efficient Communities.” which is incorporated by reference.

### STATEMENT REGARDING FEDERALLY SPONSORED RESEARCH AND DEVELOPMENT

This application was made with United States government support under Contract No. DE-AC05-00OR22725 awarded by the United States Department of Energy. The United States government has certain rights in these inventions.

### BACKGROUND

1. Technical Field

This application relates to monitoring utility consumption and more specifically to a system that monitors individual and aggregate consumption.

2. Related Art

Energy efficiency provides a method of reducing CO₂ emissions. In some methods, residential and commercial customers engage in energy efficiency efforts such as retrofitting buildings, changing incandescent bulbs to compact fluorescents, and replacing old appliances with more energy efficient replacements to conserve resources. Despite their efforts, and the efforts of others, curtailing residential and commercial energy use is still a challenge.

Today, many utility customers receive little detailed information about energy use. Some utilities provide monthly bills consisting of a total energy use and a summary of expenses. Some indicate the total energy used for the previous few months. Some utility bills provide no information about the relationship between energy consumption and weather or the age and the size of a building.

### BRIEF DESCRIPTION OF THE DRAWINGS

FIG. 1 is a block diagram of an exemplary analytic architecture.

FIG. 2 is a flow diagram of an exemplary analytic process.

FIG. 3 a graph of exemplary electricity usage data for three users.

FIG. 4 is a line diagram of IMFs and residue of electricity use for the three users of FIG. 3.

FIG. 5 is an interactive graphical user interface rendered by a visualization service served hosted by the front-end cluster of FIG. 1.

FIG. 6 is the interactive graphical user interface of FIG. 5 showing temperature data.

FIG. 7 is the interactive graphical user interface of FIG. 6 showing precipitation data.

FIG. 8 is the interactive graphical user interface of FIG. 7 showing cooling and heating days.

FIG. 9 is an interactive graphical user interface showing a comparison of usage data.

FIGS. 10 and 11 show interactive graphical user interfaces showing a selection of a geographic area.

FIG 12 is an interactive graphical user interfaces for selecting and rendering a geographic area.

FIG. 13 is an entry platform for a private portal or a utility portal.

FIG. 14 is a heat-map based on building age.

FIG. 15 is a second heat-map based on building size.

FIG. 16 is a heat-map based on electricity usage in 2007.

FIG. 17 is a heat-map based on electricity usage in 2008.

FIG. 18 is alternate block diagram of an exemplary implementation of FIG. 1.

FIG. 19 is a block diagram of a utility implementation.

FIG. 20 is a block diagram of a public view of a harvesting or mining of data.

FIG. 21 is a block diagram of a public view of exemplary usage tables.

FIG. 22 is a block diagram of a public view of an exemplary user interface.

### DETAILED DESCRIPTION OF THE PREFERRED EMBODIMENTS

A publicly and privately accessible analytic system combines a visualization service and visual communication medium with a geographic mapping tool to provide a novel energy usage feedback interface for users that may include consumers and utility analysis. The system comprises a bi-level decision support system that may visualize, compare, and analyze energy and utility usage at a household level without invading the privacy of other users. It provides access to historical energy usage data and provides opportunities tor users to visually assess the correlation patterns between weather patterns and the user's energy consumption. Some systems compare the consumption of individual users to their peer group. A peer group may be formed through an automated clustering of one or many combinations of physical locations, dwelling sizes, construction characteristics, dwelling ages and/or occupancy levels or patterns. The system may render building envelope data that correlates energy or resource consumption to one or more characteristics such as the age and size of a dwelling and render visualization “heat maps” that may provide a global or regional assessment of consumption patterns over a predetermined or programmable area and period.

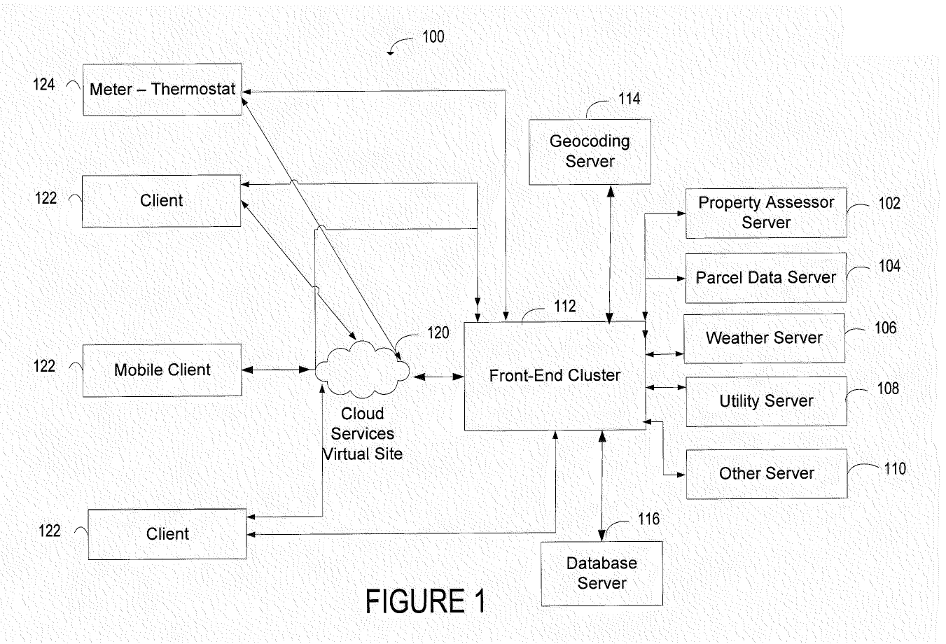

The publicly and privately accessible analytic system 100 shown in FIG. 1 integrates datasets from remote third party sources, such a data sourced from property assessors' database machines/servers 102, parcel data database machines/servers weather database machines/servers 106, and other relevant local of remote data sources 110, that are correlated to energy consumption data that may be acquired from utility database machines/server 108. A database machine is also referred to as a back-end processor that stores and retrieves data from a database such as an open source database that is coupled to a front-end processor, server, or cluster 112 through a high-speed channel; whereas a database server may provide client access to resources via a publicly and/or privately accessible distributed network or channel. A cluster may comprise a group of independent network servers that operate and appear to client devices 122 and 124 as if the independent network servers were a single server computer.

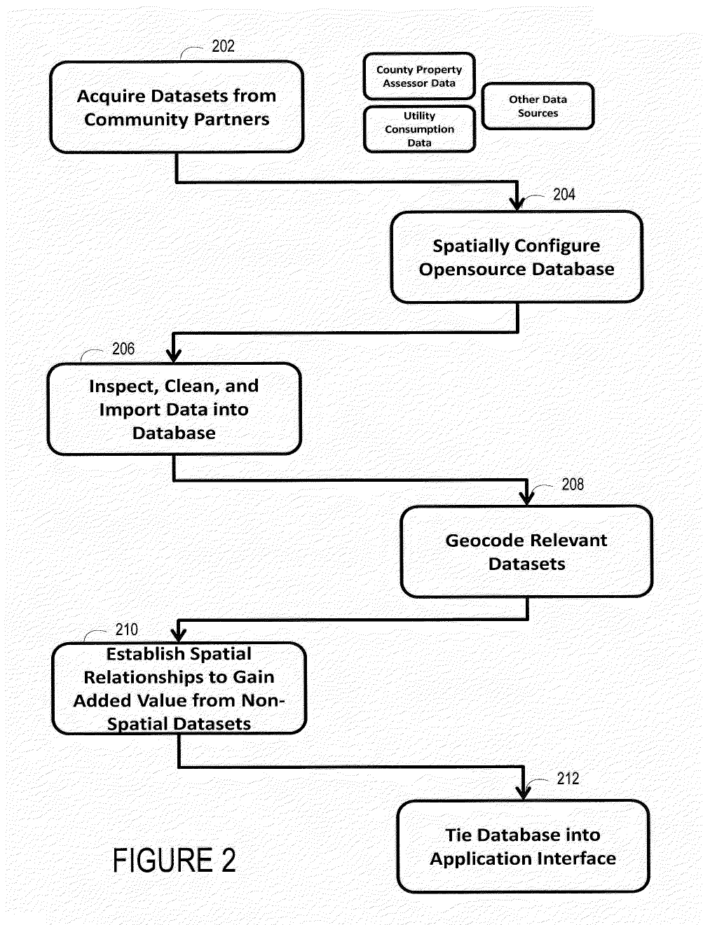

In some systems, a front-end cluster (or server) 112 acquires real-time or periodic (e.g., hourly, weekly, monthly, etc.) consumption and billing data from one or more utility database machines/servers 108 at 202 as shown in FIG. 2. The acquired information may be associated with geographic physical addresses and other information that is selectively passed to a filter or program before it is transmitted to a geocoding server 114 at 208. The filter or program that may be executed by the front-end cluster 112 accepts the input and translates the data into a desired output at 206. Features within the filter or program may strip notes, sensitive information, and/or other data from the acquired information before writing the data to a standard output destination. In some systems, the stripped data and information and its associated geographic physical address may be stored in the spatially configured open-source database server 116 that retains the acquired information. In alternative systems the acquired information may be stored in cloud-storage resources 120. A cloud or cloud based computing may refer to a scalable platform that provides a combination of services including computing, durable storage of both structured and unstructured data, network connectivity and other services. The metered services provided by a cloud or cloud based computing may be interacted with (provisioned, de-provisioned, or otherwise controlled) via one or more clients 122 or 124 and/or the front-end cluster 112.

A geocoding server or service 114 converts the addresses that are included in the standard output data into geographic coordinates like a longitude and latitude that are then stored in a shared storage device or populate a shared database. On-line property assessors' data, parcel data, and other Geographic Information Systems (GIS) data are matched and geocoded by the geocoding server or service at 208. Matching geographic coordinates associated with consumption, billing, property assessor data, GIS data and/or real-time or historical weather data are joined or are associated in spatial relationships to one another via a record to render a geocoded dataset at 210. In some systems the geocoding server or service 114 may translate the geographic coordinates of the geocoded dataset into a geographical physical address, such as a street address for example, through a reverse geocoding. At this state, some alternative systems may associate or join the notes, sensitive information, and/or other data previously stripped from the original data to supplement the spatial relationships or spatial datasets. A visualization service may then render and transmit the spatial relationships, spatial datasets and/or processed information to graphical user interfaces or application interfaces at 212 within a local or remote client 122 mobile client 122, or smart meter or smart thermostat 124. The information may comprise an on-line mapping that may render information (masking sensitive information), notes, and/or other data based on the security level approved for the user.

In some systems the front-end cluster 112 provides two portals. A public portal may provide access to individual users such as providing access to utility customers. A private portal or utility portal may provide access to commercial users such as utility analysts. Some public portals restrict information access to information belonging to the individual users without exposing the identity of others, while the utility portal may provide access to commercial users such as utility planners and analysts that may require access to all of the data that comprises the geocoded and spatial datasets. Commercial access may provide additional insights about users, and allow the commercial user to understand resource allocation and use without restriction.

As described, the publicly and privately accessible and analytic system 100 may provide aggregate or granular geocoded datasets and establish spatial relationships through many mediums and smart devices including tablets, desktop computers, smart phones, portable devices, smart energy meters and/or other machines that access Web resources. The publicly and privately accessible analytic system 100 may provide access to energy usage data at periodic intervals (for example, using hourly data, using daily data, using monthly data, etc.). Smart meters and smart thermostats 124 may further enhance some alternative systems by making energy usage data available to users as energy is consumed (e.g., in real-time) and in some instances may allow direct feedback automatically or an adjustment, in which a meter or thermostat may self-adjust based on the data accessed from the publicly and privately accessible analytic system 100 and may also self-adjust based on information the smart meter 124 or smart thermostat 124 learns from a user's adjustment or the smart meter's or smart thermostat's own sensors (e.g., proximity sensors near and far that may detect is a user is actually in a room or a dwelling, a load sensor, for example). A smart meter or smart thermostat (also referred to as an intelligent meter or intelligent thermostat) may record consumption at programmable intervals and communicates that information or data to the front-end cluster 112 at regular intervals (e.g., hourly, daily, monthly). The communication may occur through one or more publicly or privately accessible distributed networks like the Intranet and Wi-Fi networks.

In some systems the publicly and privately accessible analytic system's 100 records may record building characteristics—the age and size of a dwelling, the number of rooms, and the number of appliances and allow users to compare current consumption to prior consumption, and execute normative comparisons—by comparing one household to another based on common attributes. A disaggregation process may also provide user specific recommendations about consumption in some systems without information about the devices and appliances consuming the resources.

An Empirical Mode Decomposition (EMD) for analyzing energy usage signals, for example, may be executed in some publicly and privately accessible analytic systems 100. If given electricity usage data for a predetermined period, the system may decompose the dataset into its mode functions such that those mode functions are identified as fluctuations in the base load due to the resistance of the aggregate devices or power delivered to the devices. The devices may include lighting, appliances, healing, or cooling, or fluctuations due to activities in bedrooms, family room, kitchen, game room, etc. without any knowledge about the occupants of the dwelling and appliances in the dwelling. If smart meter or smart thermostat data is used, the smart data may validate the interpretation of these mode functions.

Some EMD techniques analyze signals from non-linear, non-stationary processes; and thus the process may be applied in several domains for signal processing. The EMD process decomposes the original signal into several intrinsic mode functions (or IMFs). Given a one-dimensional signal Xⱼ, sampled at times tⱼ, j=I, . . . N the EMD technique may decompose the signal into a finite and small number of fundamental oscillatory modes. The mode functions (or IMFs) into which the signal is decomposed are obtained from the signal itself, and they are defined in the same time domain as the original signal. The modes are nearly orthogonal with respect to each other, and are linear components of the given signal. In some systems, the following two conditions must be satisfied for an extracted signal to be called an IMF: first, the total number of extremes of the IMF should be equal to the number of zero crossings, or they should be differ by one, at most; and second, the mean of the upper envelope and the lower envelope of the IMF should be zero.

The process to obtain the IMFs from the given signal is called sifting. A sifting process may include one or more of the following acts; 1. Identification of the maxima and minima of Xⱼ. 2. Interpolation of the set of maximal and minimal points (by using cubic splines) to obtain an upper envelope (Xⱼᵤₚ) and a lower envelope (X_{flow}), respectively. 3. Calculation of the point-by-point average of the upper and lower envelopes, mⱼ=(Xⱼᵤₚ+X_{flow})/2. 4. Subtraction of the average from the original signal to yield, dⱼ=xⱼ−mⱼ; 5. Testing whether satisfies the two conditions for being an IMF, steps 1 to 4 are repeated until dⱼ satisfies two conditions; 6. Once an IMF is generated, the residual signal rⱼ=xⱼ−dⱼ is regarded as the original signal, and steps 1 to 5 are repeated to generate the second IMF, and so on.

The sifting process is complete when either the residual function becomes monotonic, or the amplitude of the residue falls below a pre-determined small value (for example, when the error is below about 0.0005, for example) so that further sitting would not yield any useful components. The features of the EMD process may assure that the computation of a finite number of IMFs within a finite number of iterations. At the end of the process, the original signal, x_{y}, may be represented as:

$${x}_{j} = {\sum }_{i = 1}^{M - 1} {d}_{j , i} + {r}_{j , M}$$

where rⱼ, M is the final residue that has near zero amplitude and frequency, M is the number of IMFs, and d_{j,i} are the IMFs.

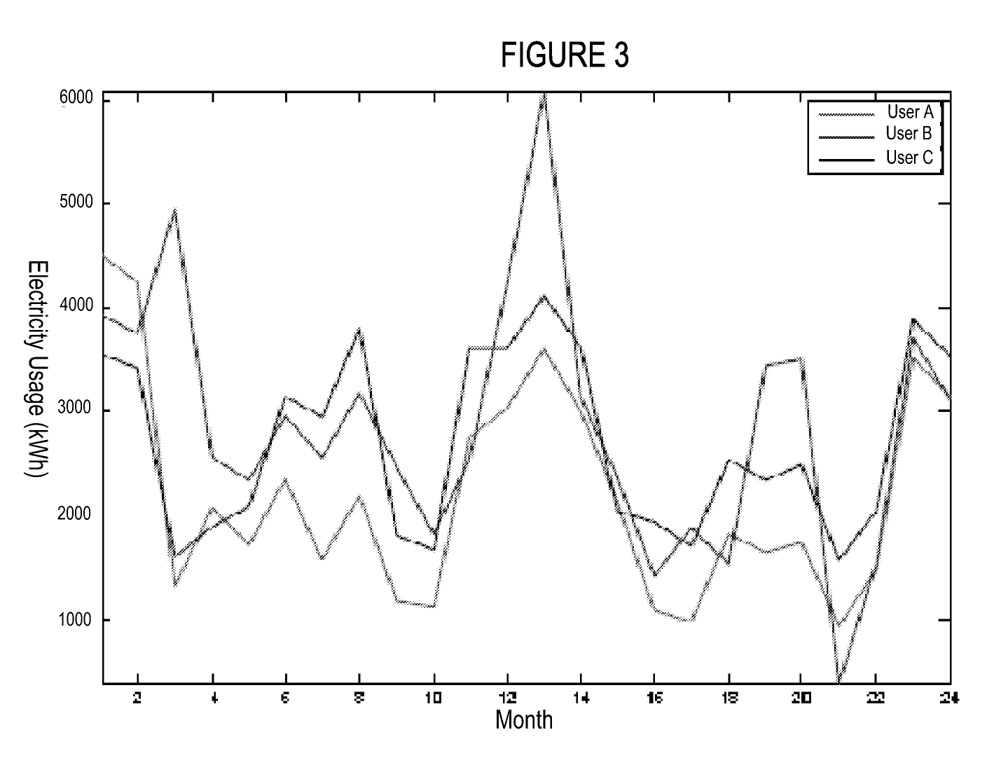

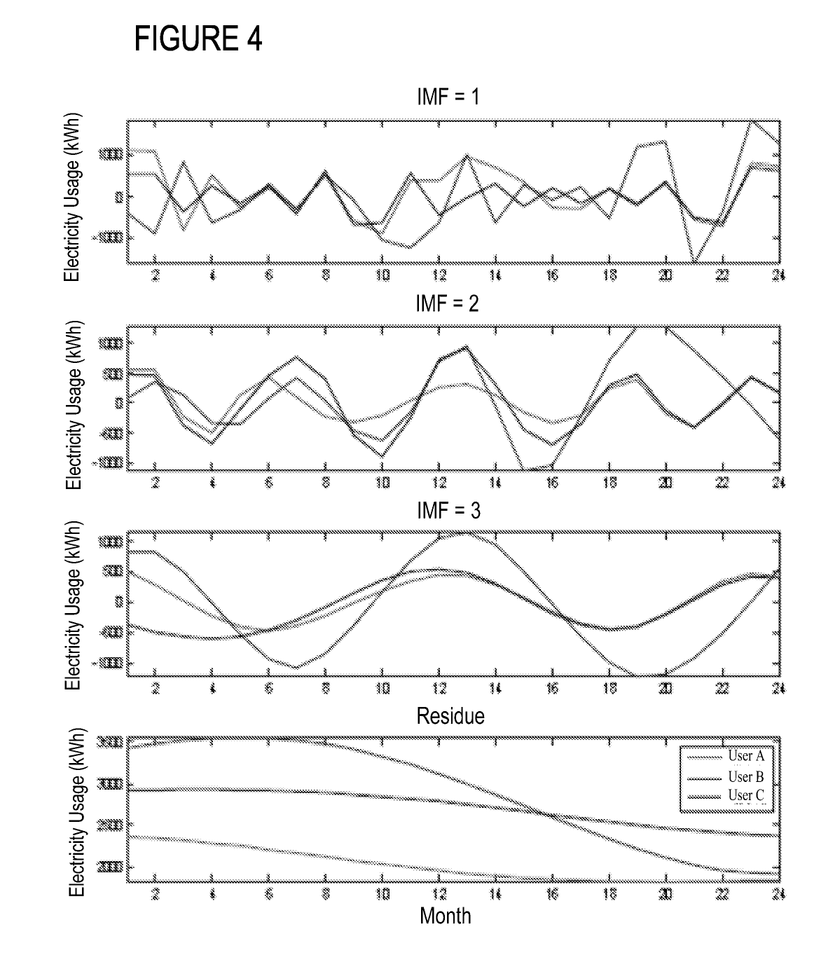

As an illustration of the sifting process, consider the monthly electricity consumption data for three users over twenty four months. The original data is shown in FIG. 3. Using the sifting process, the respective original data is decomposed into three IMFs and a residue. It should be noted that the number of IMF is automatic and data dependent. The respective decomposed signals for the three users are shown in FIG. 4. The EMD technique assured no loss of information; therefore, the summation of the three IMFs and the residue result in the original usage data for each user.

When analysing the IMFs for electricity usage, the publicly and privately accessible analytic system 100 shows the magnitude of the 4th IMF in FIG. 4 ranges between about 1905 and 3560 kWh; whereas the magnitude of the previous three IMFs ranges between approximately 1400 and 1460 kWh. Therefore, the system 100 may establish the 4th IMF as the base load in each dwelling, and each of the three IMFs as fluctuations in the base load with respect to time of the year. The system 100 may further identify that both the 2nd and 3rd IMFs represent seasonality. Moreover, the system 100 may indicate that the 2nd IMF has approximately three peaks in each year; whereas, the 3rd IMF has only two peaks in each year, The peaks in the 2nd IMF coincide with the month of January, July, and December. The peaks in the 3rd IMF coincide with the month of January and December. In addition, the 2nd IMF has two minima around April and October in each year; while, the 3rd IMF has one minimum around July in each year. Some systems may identify the 2^{nd} IMF and 3^{rd} IMF as complements of each other. It may determine that the 2nd IMF is due to fluctuations in cooling the dwelling; whereas, the 3rd IMF is due to fluctuations in heating the dwelling. Looking at the 1st IMF, the system 100 may identify the frequency of the signal fluctuations and changes that occur every month that may be attributed to occupants' behavior and make recommendations based on the identified behavior.

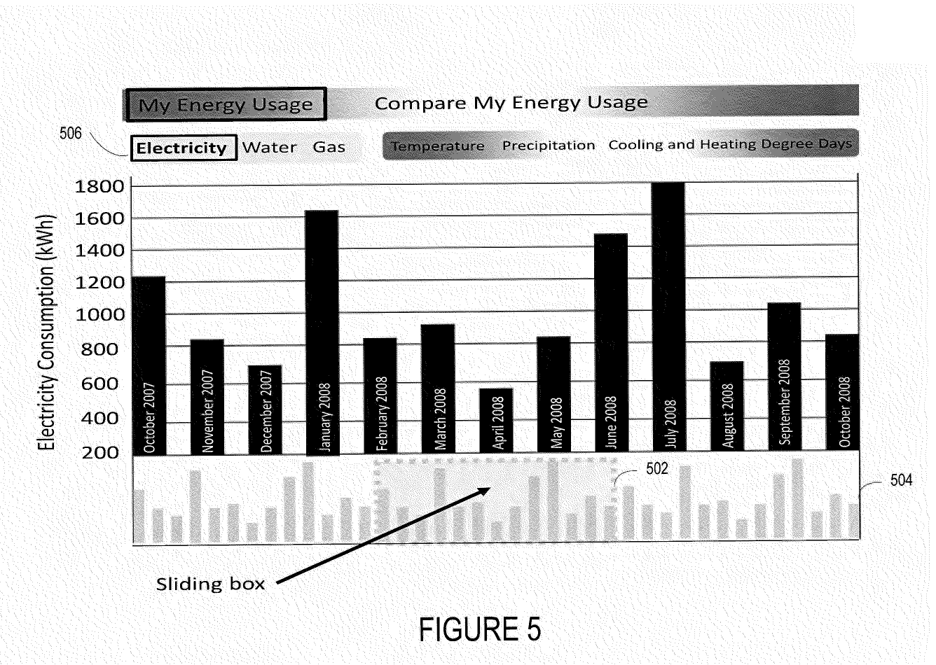

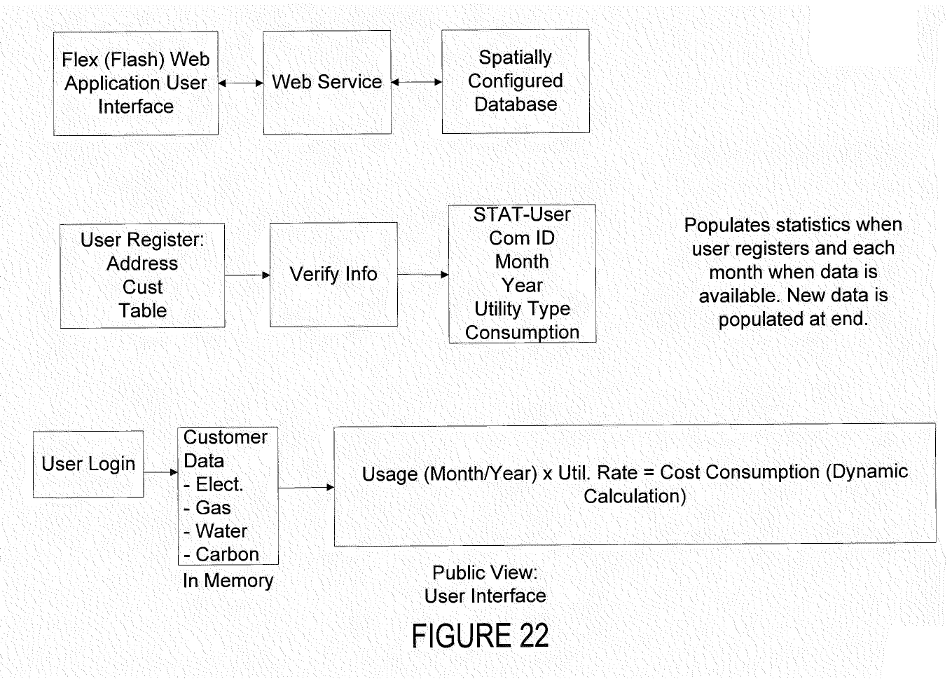

From a user's perspective, the publicly and privately accessible analytic system 100 may be divided into profiles of energy usage, comparison of energy usages among peers, and self-analysis of energy consumption patterns that may be rendered through the visualization service and visual communication medium. Once a user is registered on the publicly and privately accessible analytic system 100 (an exemplary flow is shown in FIG. 22), relevant data for their dwelling is captured automatically and the geocoded and spatial relationships or spatial datasets are pre-generated or generated in real-time by the front-end cluster 112 through a Web-oriented server-side scripting (as opposed to a client-side). Once logged into die system, the visualization service provides the user with access to historical energy usage data for their dwelling that shows the temporal trends in their usages and behavior through a client device 122 and 124 and a tangible or wireless medium. Since some of the data is automatically harvested or mined from utility and other third party sources 102-110, new occupants of a dwelling may have access to usage data for the previous occupants since data may be linked to a geographical physical addresses rather than a prior user. FIG. 5 shows an interactive graphical user interface rendered by the visualization service. The graphical user interface shows historical electricity usage data. The user controlled sliding time-of-interest selection window 502 shown in an option-selection area 504 may be controlled by touch or an absolute or relative pointing device to illustrate usage patterns in greater detail near the top of the graphical user interface.

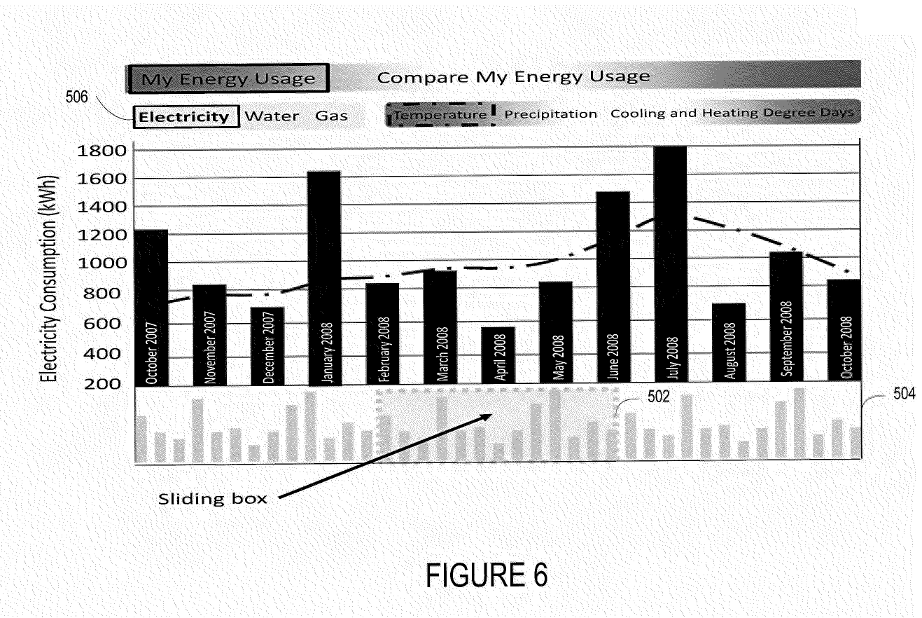

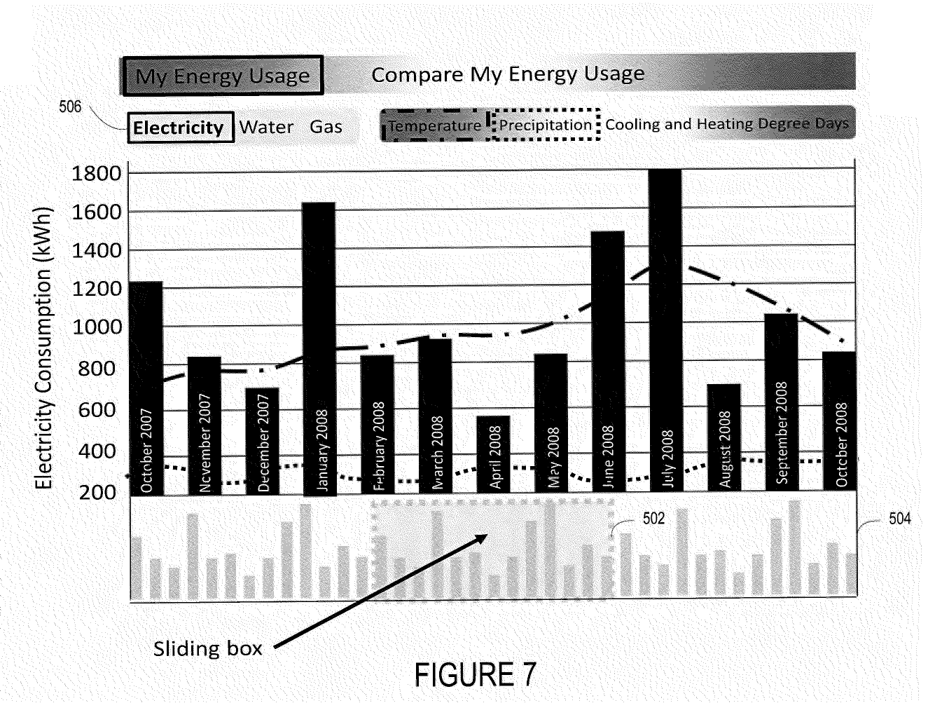

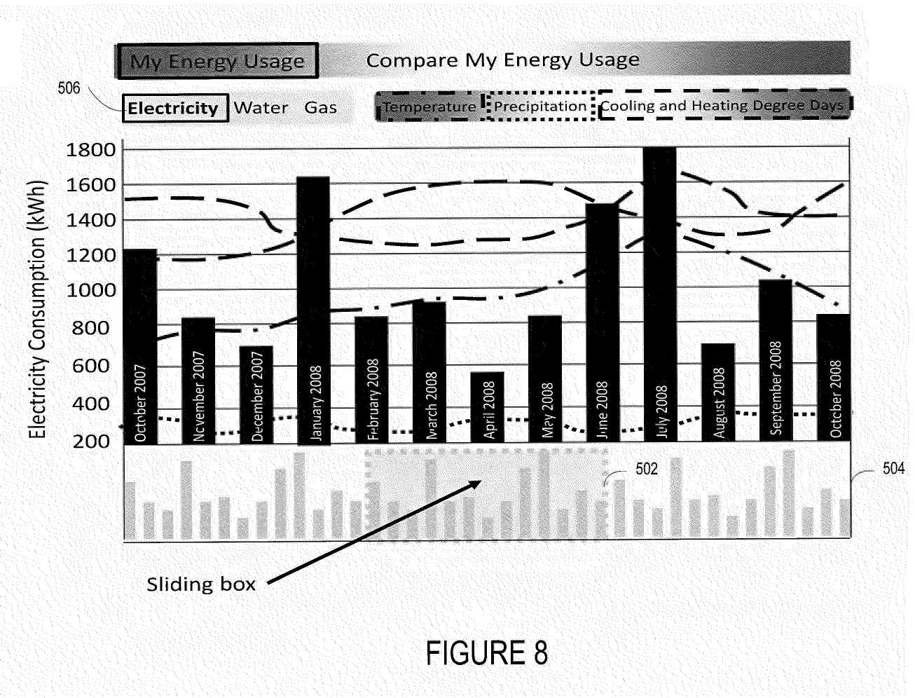

As shown in FIG. 5, a user can view usage data for multiple months simultaneously. A pre-programmed number of months may be selected as shown in FIG. 5, In some systems the user can change the size of the sliding time-of-interest window to select fewer or more months in the upper portion of the graphical user interface. The user can drag the sliding time-of-interest selection window 502 to the left or right to view older or newer data, respectively. In addition, the user may select one of several options in a second option-selection area 506 that renders radio buttons or selection options near the top of the graphical user interlace to select consumption of other commodities such as water consumption (as shown in the second option-selection area 506) and gas usage, for example. In addition, the visualization service and graphical user interface allows users to overlay average temperatures data as shown in FIG. 6 or precipitation data as shown in FIG. 7 or cooling and heating degree days data as shown in FIG. 8 for their geographic areas. Other graphical user interfaces not shown include a monthly cost of energy usage which is the dollar equivalent of the energy usage. The presentation of these geocoded datasets and the associated interactive overlays allow users to assess their individual energy consumption with respect to their environmental surroundings.

To help users understand how their energy usage compares to others customers, a comparative graphical user display compares usage data among peers based on what is known about the user's energy consumption and an assessment of their property. The property assessment data used for this purpose may include the year the dwelling was built, the square footage of the dwelling, the number of rooms in the dwelling, and other property-specific data that is automatically mined from property assessors' database machines/servers 102, parcel data database machines/servers 104, and/or other remote third party sources 110, The front-end cluster 112 harvests the data and aggregates the data through a peer classifications or aggregations. Peer-classes may be formed through one or more attributes such as the size and age of a dwelling within a programmed tolerance range, the dwelling's style, the materials it is built with (e.g., vinyl or brick), household size, number of stories, etc. Thus, the classification allows users living in a twenty-five year old house of size 1000 sq. ft., for example, to be compared to other houses aged between twenty-three and twenty-seven years old and between 800 sq. ft. and 1200 sq. ft. All the houses that satisfy this criterion may be classified as the user's peers.

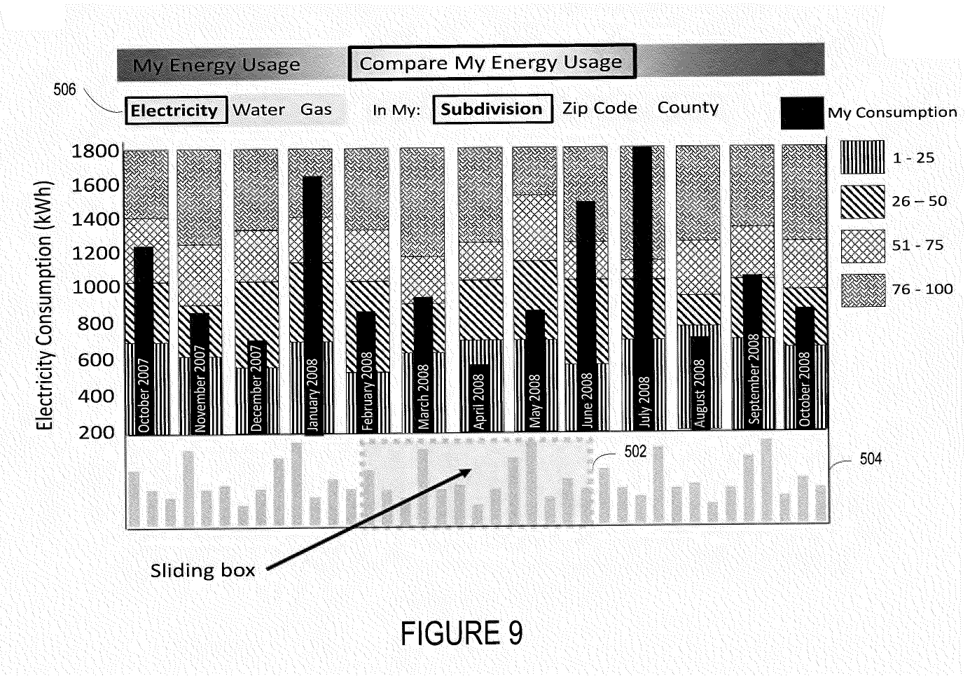

A graphical user display showing a collection of the outputs of such a comparison for a customer to peers in a same subdivision is shown in FIG. 9. As shown, the “dark bar graph” represents the customer's electricity usage for each month. The “linear shading” extending from the x-axis represents consumption for the lower 25 percent of their peers; the negative sloped “angular shading” represents the next 25 percent (or 25 to 50 percent) of their peers. The “cross-batching” represents the 50 to 75 percent mark for their peers; and the upper most “patterned shading” represents the upper 25 percent of their peers. Again, users can drag the sliding time-of-interest selection window 502 in the option selection area 502 to see how comparisons change over time.

From the snapshot shown in FIG. 9, a user's consumption is below the 25 percent level in two of the 13 months, between the 26 and 50 percent level in five months, and within the 51 and 75 percent level in the three months and within 76 and 100 percent in the remaining three months. These dynamic visual queries rendered by the visualization service compare users to others; initiate some questions; and possibly take actions to achieve consistency in their comparison. Furthermore, the publicly and privately accessible analytic system 100 may automatically identify and label the months that are “best in class”. For example, in the month of August (that is, the 12th bar in FIG. 9), the consumption for this user is about half the size of the lower 25 percent mark. And, when automatically identified, some front-end cluster may share this data with practices that resulted in a “best-in-class” rating with remote systems too. For example, if a user elects to share data, the front-end cluster may transmit the data and/or the practices that earned the ratings through a wireless or tangible medium to a social network.

From a user's perspective, self-analysis of energy consumption patterns oilers the users an opportunity to compare their consumption to that of their peers in other geographical areas too. To achieve this, users can specify the subdivision, zip code, or county of interest to them through a graphical user interface that initiates a comparison at the front-end cluster 112, hike the prior perspective, the comparison of consumption may be made relative to their peers. When differences are detected or deficiencies within the comparisons are found, the font-end cluster 112 may deliver the comparisons with on-line advertising that notifies the users of product(s) or service(s) and the reasons why the user should select or learn more about the product or service in question. The advertising may be monitored in real-time and is preferably target to the viewer's needs or viewing history.

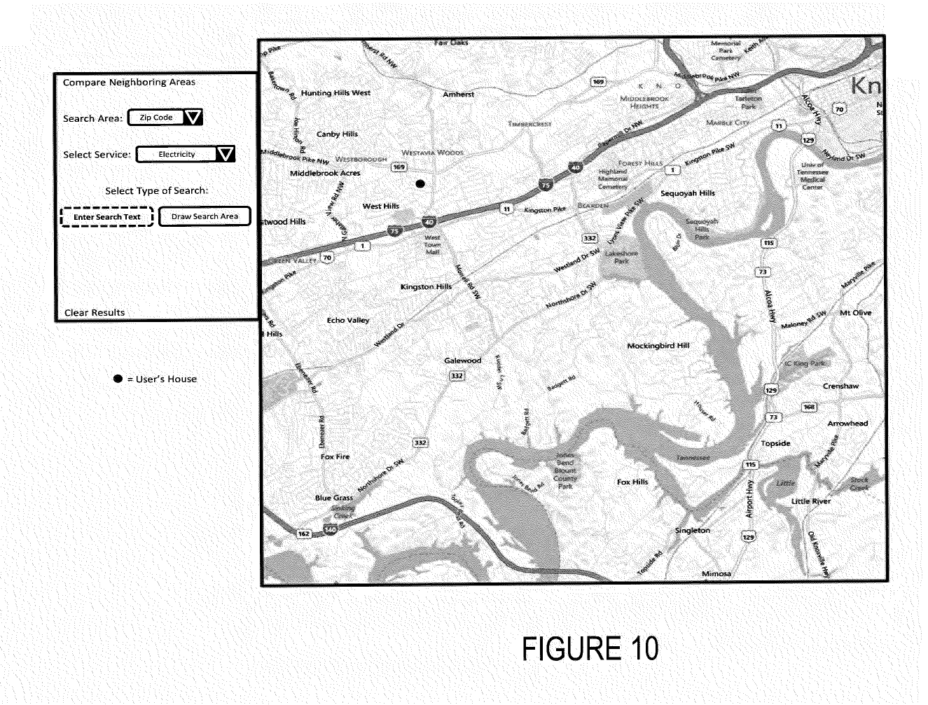

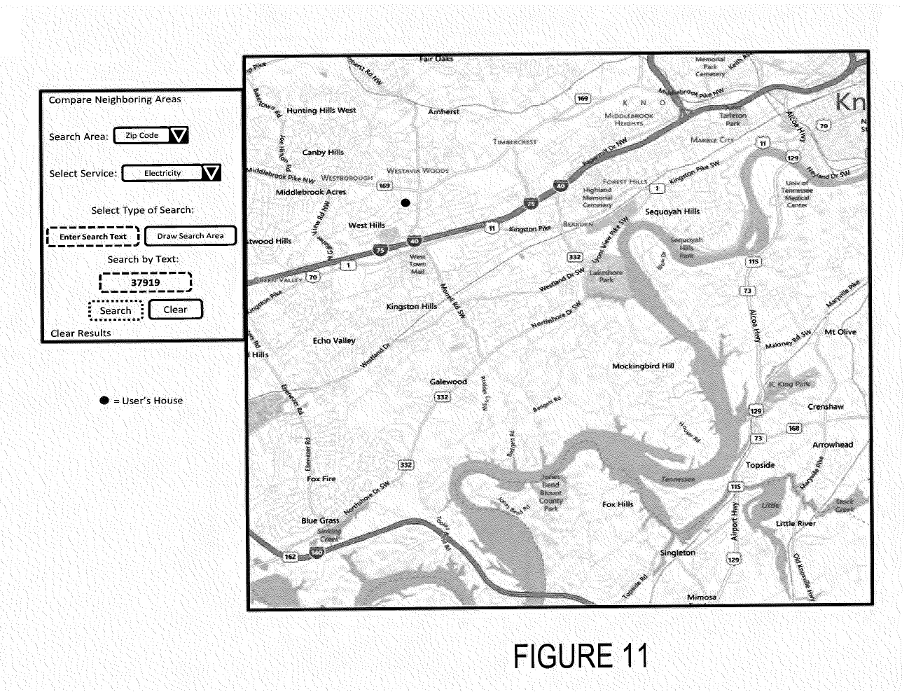

As shown by the exemplary graphical user interface of FIGS. 10 and 11, a user can specify a search area be entering a service mark used to expedite delivery of correspondence to an assigned area. Such a service mark may include an area zip code, subdivision, and/or county. The graphical user interface may also provide a list of options from which a user can make a selection in order to choose the usage data to be used for the comparison, such as electricity, water, and gas for example.

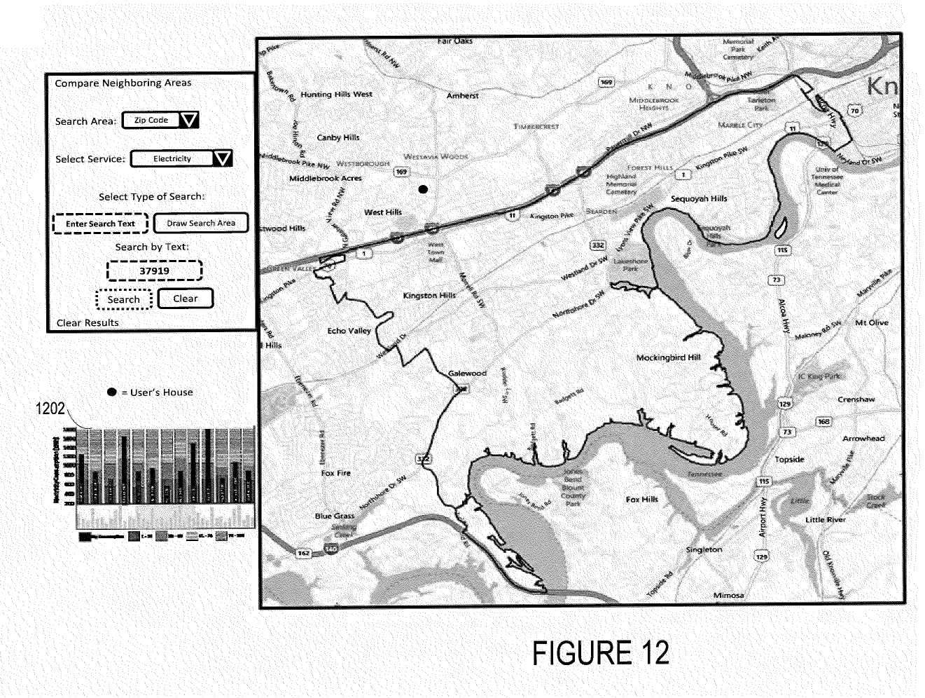

In an alternative graphical user interface a user may generate customized maps, by drawings on or editing an existing map to identify a desired location. As shown in FIG. 12, a user may select or identify an area of interest. A user may draw some lines that can be manipulated by many mid-points or select predetermined shapes that may be overlaid on a desired area, The user may further designate the color, opacity, and line thickness, of the selection object overlaying the desired area. In some other alternative systems 100 the user may also designate a blend mode that establishes how the underlying data associated with the map below is displayed—whether it be shown above, adjacent, or near the above shape or drawing that comprises the designated area, in some publicly and privately accessible analytic systems 100 the blend mode may keep the underlying colors or markers of the underlying map in view without blurring the differentiators out. This feature allows the user to color the area and still see ail of the shapes of the roads and highway markers that may underlie the colored overlay.

Once an area is selected, multiple outputs are presented for the users. One output may comprise a map that shows the location of the user's house and the boundary for the search area. An example of this output is also shown in FIG. 12 for a user (dot) located in zip code “37919”, but the user is interested in comparing consumption to zip code “XXXXX” (as shown in the geographic outline on the map).

A second output may comprise a graphical user interface that compares the user's consumption to the average consumption of peers in this zip code area as shown at 1202 in FIG. 12 that in alternative systems may also include banner ads. As in the previous graphical user interfaces, a user may manipulate the displayed content by selecting and dragging the chart in a substantially horizontal direction to see the prior use data.

An optional usage diary allows users to “tag and track” their consumption pattern and perform some dwelling-specific analysis. The “tag and track” capability enables users to keep a diary of known events or add annotations to events during a monitoring period such as each month that could have resulted in a higher or lower overall consumption in that time period. A user may select the time of Interest (e.g., the month of interest) and make a note for their use, it may include for example a note such as. “hosted more guests”, “on vacation”, “replaced an old appliance”, “sealed the windows”, etc.

Some publicly and privately accessible analytic system 100 may process the tagged information or identify the tag as an event to identify trends that may begin at a particular time of the tagging using the tagged information. For example, if an energy-efficient event occurs, the information may be tagged to the appropriate time, and the savings in consumption, if any, is then automatically tracked by the publicly and privately accessible analytic system 100 thereafter.

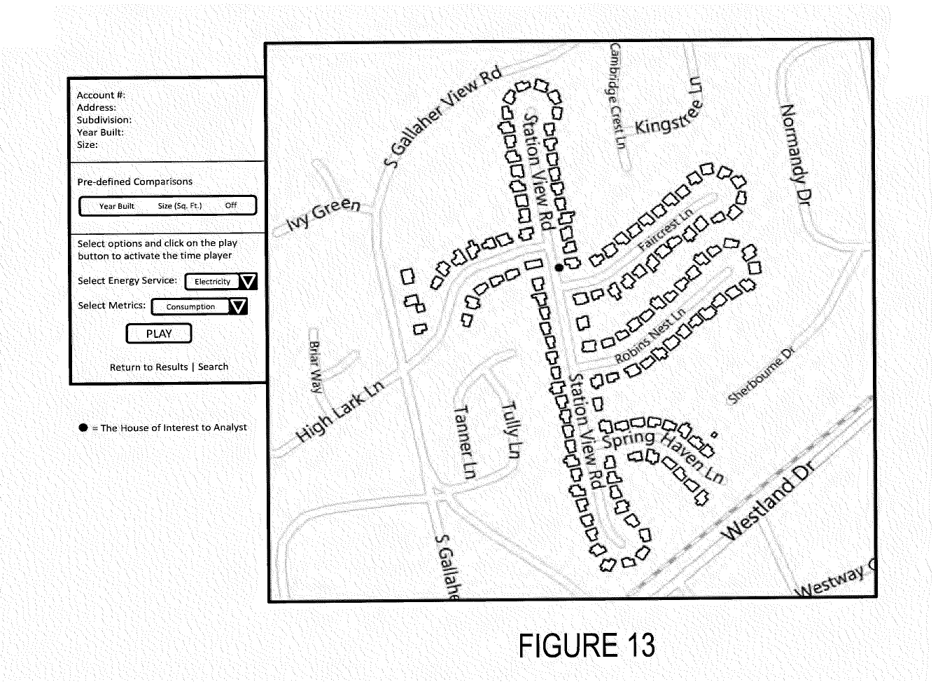

Besides providing individual users with access to data, a private portal or utility portal may provide access to commercial users such as utility analysts. The private portal allows commercial users to query the publicly and privately accessible analytic system 100 for specific customers as well as for a group of customers. To query for a specific customer, the commercial user may enter information about a specific user. This information may include for example an account number or similar unique identifier or address of a house that may be entered in the dialog box shown in FIG. 13.

Once an account number or similar information is submitted, the visualisation services of the application may enlarge a selected portion of a graphical image such as location of the dwelling of the desired user (or customer) on a map (not shown). In addition, the blending mode may render information about that dwelling above or below the map or via a separate dialog box, The information may include the address for the account number, the subdivision it is located, the year the house was built, and the size of the house.

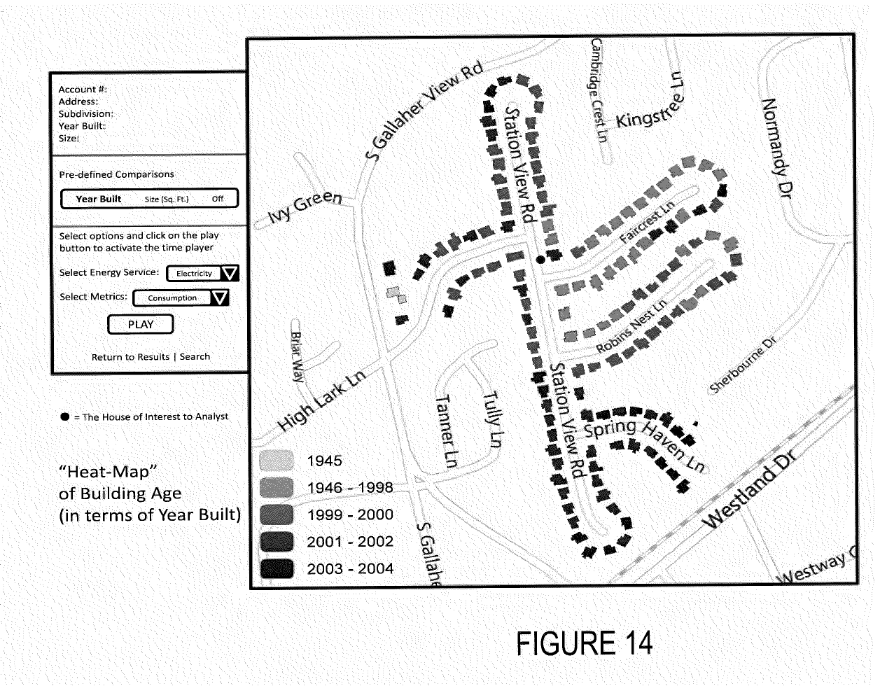

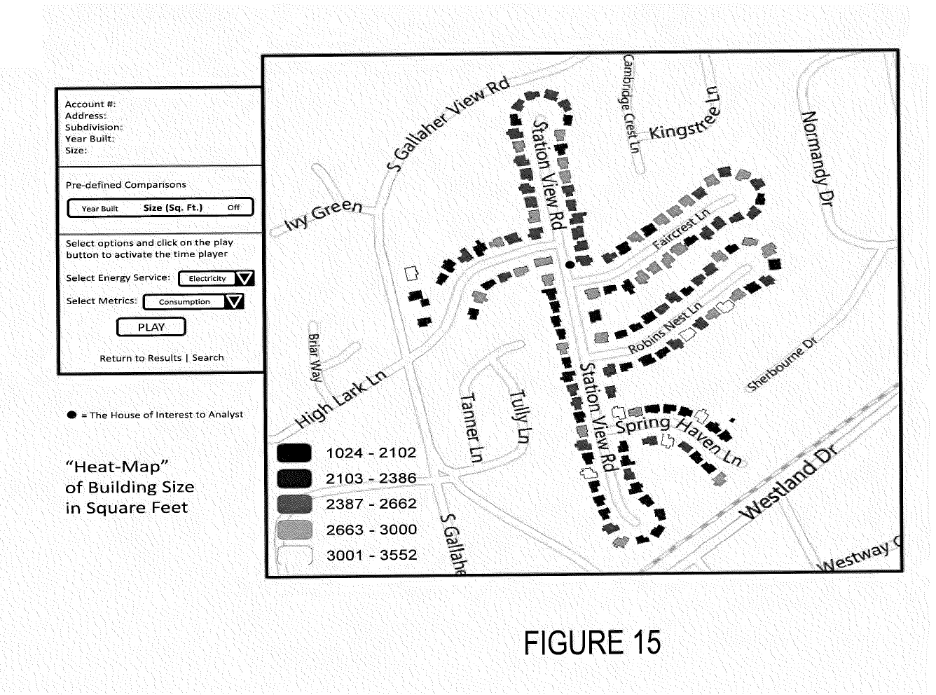

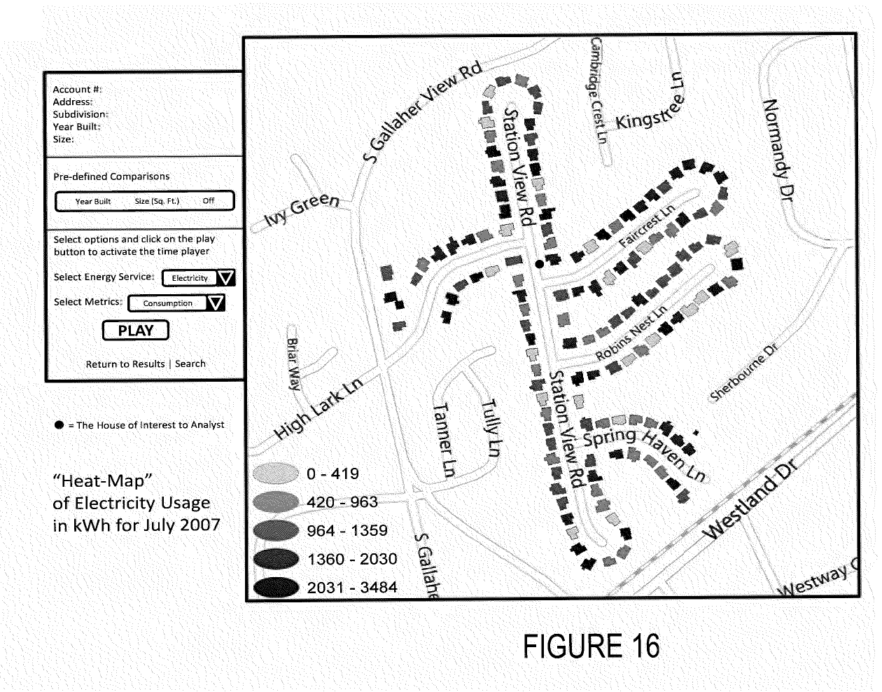

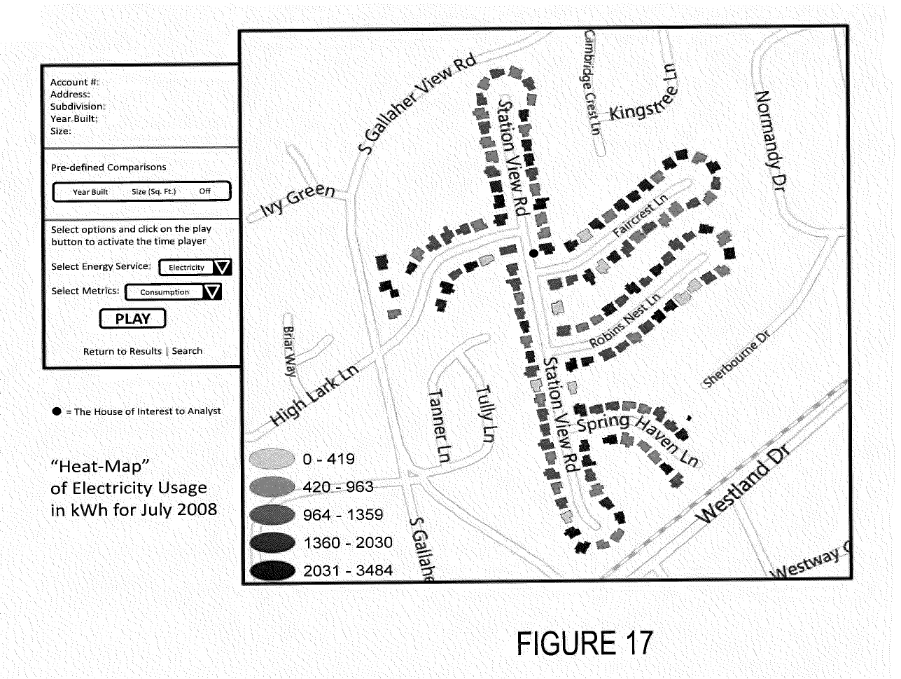

Through another graphical user interface a commercial user can generate one or more real-time “heat maps” of year built or age as shown in FIG. 14, size as shown in FIG. 15, electricity usage as shown in FIGS. 16 and 17, usage per square foot of houses in a geographical area, etc. A heat-map within the publicly and privately accessible analytic system 100 is a rendering of the footprint for each building based on the numerical value of the metric of comparison. With smart meter or smart thermostat data, the heat-map capability can be extended to visualize energy consumption data in real-time. And, in some systems may solicit specific user opinions in real-time regarding usage or consumption that is retained by the front-end cluster. A real-time operation may comprise an operation matching a human's perception of lime or a virtual process that is processed at the same rate (or perceived to be at the same rate) as a physical or an external process.

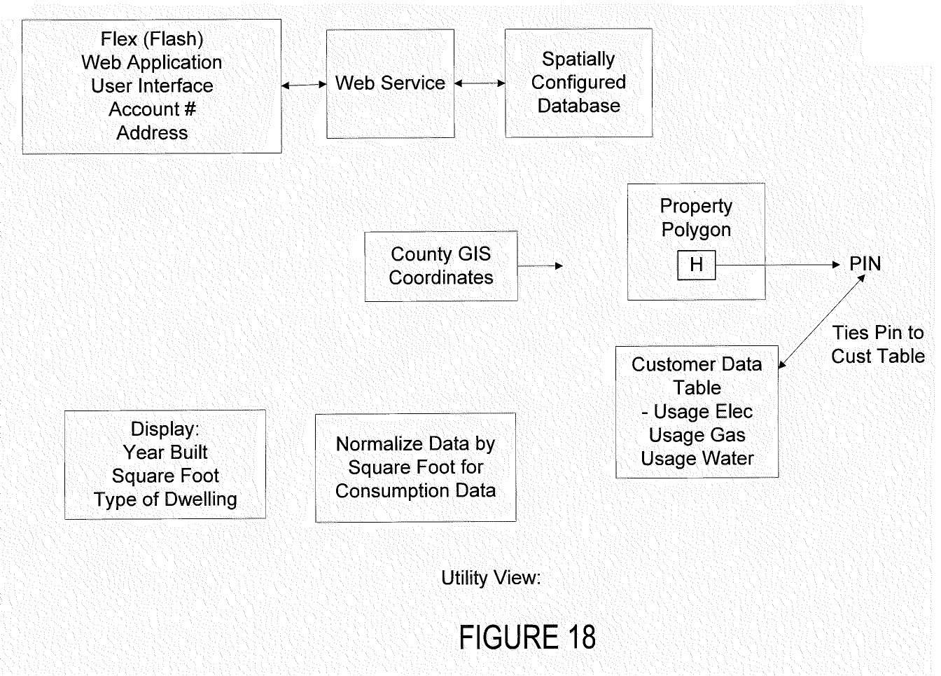

A utility view of another exemplary implementation of a publicly and privately accessible analytic system 100 is shown in FIG. 18. A semi-transparent window that provides contextual access to commonly used tools like a dashboard may be rendered in the display through animation sequences rendered in Flash application through a Web application interlace. The geocoded and spatial datasets retained in the spatially configured database may render display pages such as the exemplary pages shown in the block diagrams.

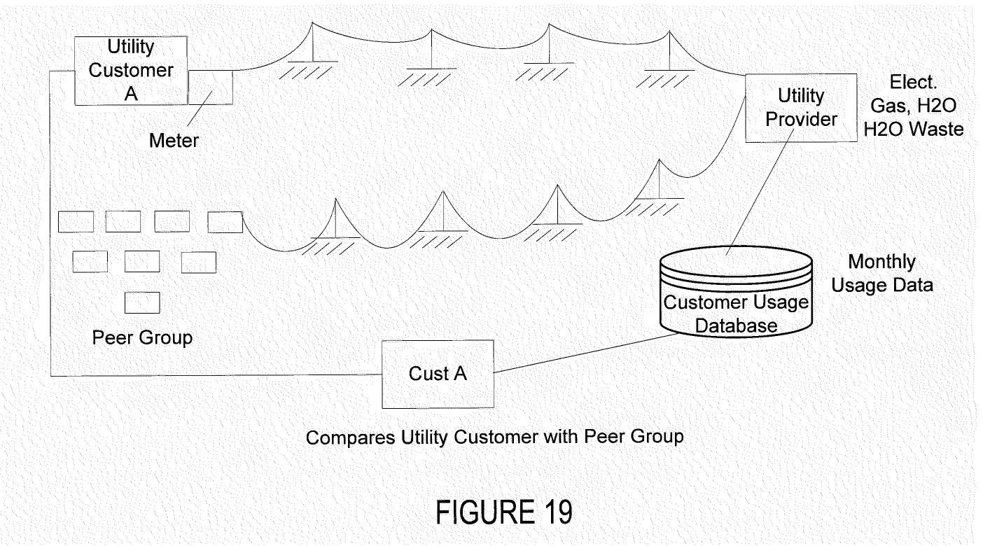

FIG. 19 is a block drawings of a utility implementation of the publicly and privately accessible analytic system 100. The system shows the integration and interlinking of users residing locally or around the world. The system interconnects users and utilities that supports, delivers data, and accesses the spatial data sets on the publicly and privately accessible analytic system 100.

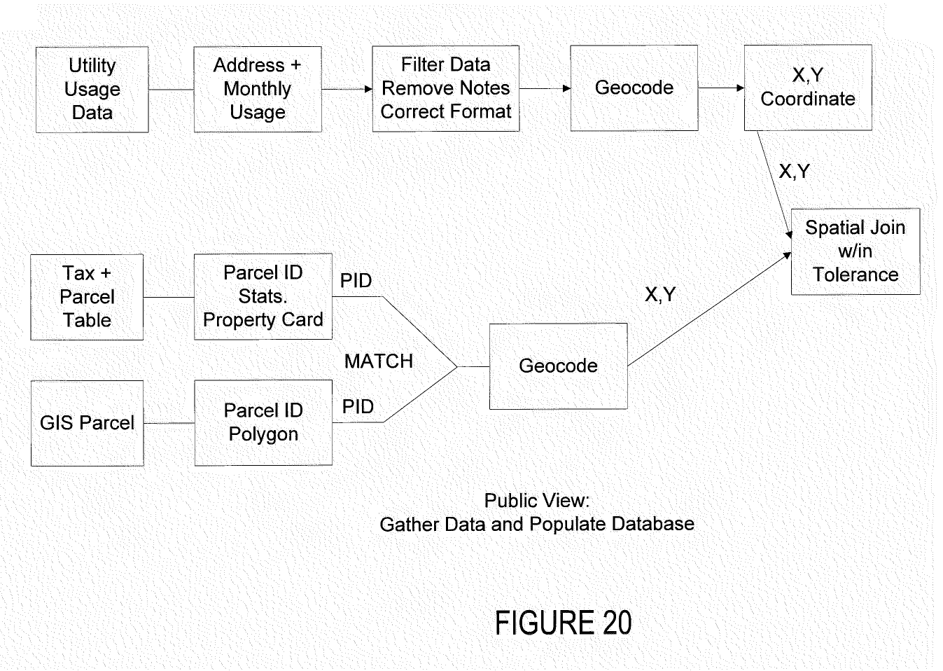

From a public view of one exemplary implementation shown in FIG. 20, consumption data is harvested or mined from several sources including: utility database machines/servers (e.g., electrical gas, water, and waste water), property assessors' database machines/servers (e.g., tax parcel tables), and GIS database machines/servers that is stored in a database such as a SQL database. The data may include a customer's address, utility usage data; tax assessment data, a parcel ID, and other demographics or statistics relating to real property or data that may be associated with a property ID (e.g., size of dwelling, etc.). The GIS parcel data may include a Parcel ID (PID) and an identifier of a property polygon that may include GIS coordinates. Once filtered to remove unneeded data or correct format inconsistencies, the tax assessment data and GIS parcel datasets are merged through a matching of parcel IDs. The datasets are then geocoded through a visualization service to render high resolution datasets. The datasets may he layered onto an interactive real-property map. To minimize differences between data sources, the data may be spatially joined if the data lies within predefined tolerances.

New data analysis algorithms developed for understanding the spatial patterns of energy usage over time for comparison may be applied to the analysis herein. Exploratory data analysis may be applied for implicit knowledge in data sets. Tendencies or patterns in the data are analyzed using clustering techniques such as K-means, a fast clustering algorithm. Unfortunately, traditional K-means analysis only clusters observation vectors in feature space. Here, the combination of K-means algorithm with spatial features for an online spatial constrained K-means may generate spatially related datasets. Based on the detected patterns, the publicly and privately accessible analytic system 100 may rank consumption data to identify consumers with similar patterns. In some applications the rank may be applied as a pattern threshold for each consumer in each cluster. When a customer exceeds their pattern threshold, a negative alarm or message may issue (or be transmitted from the front-end cluster 112). A positive alarm or message may similarly issue (or be transmitted from the front-end cluster 112) if consumption moves to a lower ranking. Such additional information may assist users to determine what activities are responsible for their new ranking. For ranking the detected patterns, a distance measure such as variant of Kullback-Leibler divergence may be used. A suitable distance measure for energy consumption data may also be used. Furthermore, when the system 100 accesses LandScan Global population database, the system 100 may link patterns in consumption to demographic and socio-economic factors such as the number of rooms in a house, the number of occupants, and per capital income for rendering additional analysis into the usage data.

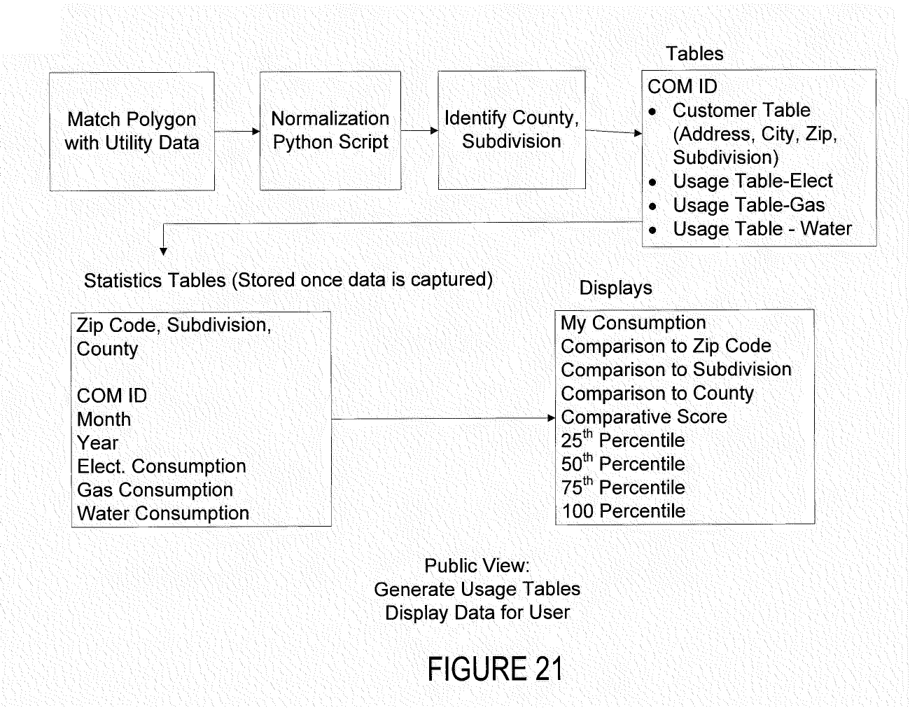

As shown in FIG. 21, some GIS polygon data is matched with the utility data and normalized with a python script. Each parcel ID may be assigned to a regional county and local subdivision in files composed of records and tables. The tables and records may include: address, county, city, zip code, subdivision, electricity usage data, gas usage data, water usage data, and waste water usage data for example. Consumption data may be derived from the customer data and stored in records or tables as the data is harvested or mined (e.g., monthly, hourly, etc.). These statistics may compare the customer with peer groups in the same zip code, county, city, subdivision, etc. The functions and results may be made available to a user through a Web-based computer application display or a semi-transparent window following a user's authentication as shown in FIG. 22. The semi-transparent window provides contextual access to commonly used tools like a dashboard, f he dashboards may render interactive graphical charts of consumption as represented via block diagrams in FIG. 22, comparison to peers, and comparative rankings.

The processes and systems described may execute software encoded in a non-transitory signal bearing medium, or may reside in a memory resident to or interfaced to one or more processors or controllers that may support a tangible communication interface, wireless communication interface, or a wireless system. The memory may retain an ordered listing of executable instructions for implementing logical functions and may retain one or more database engines that access files composed of records, each of which contains fields, together with a set of operations for searching, sorting, recombining, and/or other functions that are also retained in memory. A logical function may be implemented through digital circuitry, through source code, or through analog circuitry. The software may be embodied in any non-transitory computer-readable medium or signal-bearing medium, for use by, or in connection with an instruction executable system, apparatus, and device, resident to system that may maintain a persistent or non-persistent connection with a destination. Such a system may include a computer-based system, a processor-containing system, or another system that includes an input and output interface that may communicate with a publicly accessible distributed network and/or privately accessible distributed network through a wireless or tangible communication bus through a public and/or proprietary protocol.

The on-line cloud storage resources 120 may include nonvolatile memory (e.g., memory cards, flash drives, solid-state devices, ROM/PROM/EPROM/EEPROM, etc.), volatile memory (e.g., RAM/DRAM, etc.), that may retain a database or are part of database server(s) 116 that retains data in a database structure and supports a database sublanguage (e.g., structured query language, for example) that may be used for querying, updating, and managing data stored in a local or distributed memory of the databases. The database is accessible through database engine or a software interface between the database and user that handles user requests for database actions and controls database security and data integrity requirements. A client device 120 (that includes mobile ceil phones, wireless phones, personal digital assistants, two-way pagers, smartphones, portable computers, tablets, etc. in some systems 100) may be configured to communicate alone or with or through one or more tangible devices, such as a personal computer, a laptop computer, a set-top box, a customized computer system such as a game console, and other devices, for example.

A “computer-readable medium,” “machine-readable medium.” “propagated-signal” medium, and/or “signal-bearing medium” may comprise a non-transitory medium that contains, stores, communicates, propagates, or transports software tor use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection having one or more wires, a portable magnetic or optical disk, a volatile memory such as a Random Access Memory (RAM), a Read-Only Memory (ROM), an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The term “coupled” disclosed in this description may encompass both direct and indirect coupling. Thus, first and second parts are said to be coupled together when they directly contact one another, as well as when the first pan couples to an intermediate part which couples either directly or via one or more additional intermediate parts to the second part. The term “position,” “location.” or “point” may encompass a range of positions, locations, or points. The term “substantially” or “about” may encompass a range that is largely, bin not necessarily wholly, that which is specified. It encompasses all but a significant amount. When devices are responsive to commands events, and/or requests, the actions and/or steps of the devices, such as the operations that devices are performing, necessarily occur as a direct or indirect result of the preceding commands, events, actions, and/or requests. In other words, the operations occur as a result of the preceding operations. A device that is responsive to another requires more than an action (i.e., the device's response to) merely follow another action. The abbreviation “GIS” refers to the software embodied in a non-transitory medium used for processing spatial data. The term “GIScience” refers to the techniques and methods that drive the software in the non-transitory medium.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. An analytic system comprising:
a communication interface configured to connect to a client device;
a front-end cluster comprising a group of independent network servers that acquire user billing data and consumption data from one or more utility database machines and acquires Geographic Information Systems data; and
a geocoding server configured to convert selected data rendered by the front-end cluster into geographic coordinates;
where the front-end cluster is configured to respond to a request received from the client device for a comparison of a user's utility use to a peer group's utility usage,

2. The analytic system of claim 1 where the client device comprises a mobile client device.

3. The analytic system of claim 1 further comprising a filter configured to strip data from the user billing data and the consumption data and convert the filtered data into a second data format.

4. The analytic system of claim 1 where the geographic coordinates comprise a longitude and a latitude.

5. The analytic system of claim 1 where the front-end cluster is configured to match geographic coordinates associated with the billing data and consumption data to property assessor data and weather data.

6. The analytic system of claim 1 where the weather data coincides with the consumption data and time and the association occurs in real-time.

7. The analytic system of claim 1 where the front-end cluster is further configured to execute a visualization service that transmits spatial relationships and spatial datasets to remote client devices.

8. The analytic system of claim 1 where the front-end cluster is configured to communicate with an intelligent meter that is configured to record a users consumption at periodic intervals and communicates the consumption data directly to the front-end cluster through a publicly accessible network and the communication interface.

9. The analytic system of claim 1 where a network server that comprises a part of the front-end cluster is configured to generate the peer group through an automated clustering of actual user consumption based on two or more attributes associated with each consumption comprising physical locations, dwelling sizes, construction characteristics, dwelling ages, and occupancy levels.

10. The analytic system of claim 1 where the front-end cluster is further configured render specific user recommendations through a mode decomposition process executed by the front-end cluster.

11. The analytic system of claim 1 where the front-end cluster is further configured to render energy usage profile displays.

12. The analytic system of claim 1 where the front-end cluster is further configured to render peer comparison displays of energy usage.

13. The analytic system of claim 1 where the front-end cluster is further configured to render a self-analysis graphic display of energy consumption patterns.

14. The analytic system of claim 13 where the displays are based on data rendered from a user drawing on a geographical map through a graphical user interface.

15. The analytic system of claim 13 where the displays are based on a blend mode that establishes how underlying data associated with the geographical map is displayed, such that the underlying data is rendered above, adjacent, or near the user's drawing.

16. An analytic system comprising:
a communication interface configured to connect to a client device;
a front-end cluster comprising a group of independent network servers that acquire user billing and consumption data from one or more utility database machines and acquires property assessment data from a property assessor server; and
a geocoding server configured to convert selected data rendered by the front-end cluster into geographic coordinates;
where the front-end cluster is configured to respond to requests originating from the client device for a comparison of a user's utility use to a peer group's use.

17. The analytic system of claim 16 where the front-end cluster is further configured to render energy usage profile displays.

18. The analytic system of claim 17 where the front-end cluster is further configured to render peer comparison displays of energy usage.

19. The analytic system of claim 17 where the front-end cluster Is further configured to render a self-analysis graphic display of energy consumption patterns.

20. The analytic system of claim 17 where the displays are based on data rendered from a user drawing on a geographical map through a graphical user interface.
